(19) United States
(12) Patent Application Publication
(10) Pub. No.: US 2017/0315964 A1
(43) Pub. Date: Nov. 2, 2017

(54) WEB PAGE REFORMATTING METHOD AND APPARATUS, COMPUTING DEVICE AND NON-TRANSITORY MACHINE READABLE STORAGE MEDIUM

(71) Applicant: GUANGZHOU UCWEB COMPUTER TECHNOLOGY CO., LTD., GUANGZHOU, GUANGDONG (CN)

(72) Inventor: JINHE ZENG, GUANGZHOU (CN)

(21) Appl. No.: 15/522,556

(22) PCT Filed: Oct. 21, 2015
(86) PCT No.: PCT/CN2015/092432

§ 371 Date: Apr. 27, 2017

(30) Foreign Application Priority Data
Oct. 31, 2014 (CN) 201410606504.8

(51) Int. Cl. G06F 17/21; G06F 3/0488; G06F 3/0484; G06F 17/30; G06F 3/0482

(52) U.S. Cl. CPC G06F 17/211; G06F 3/04883; G06F 3/04845; G06F 3/0482; G06F 17/3089

(57) ABSTRACT

Disclosed are a web page reformatting method and apparatus, a computing device, and a non-transitory machine readable storage medium, which, by acquiring a predefined action performed by a user on a target element in a web page and a corresponding action parameter and computing an updated style of the target element in the web page according to the action parameter, achieve the objective of reformatting the target element in the web page. The technical solutions of the present invention allow users to adjust the format of disorderly web page contents and can adapt to reading styles of different users, thereby providing good flexibility and greatly improving users' reading experience.

### BACKGROUND

### Technical Field

The present invention relates to the field of computer technologies, and in particular, to a web page reformatting method and apparatus, a computing device, and a non-transitory machine readable storage medium.

### Related Art

With a rapid development of Internet technologies, networks present increasingly rich contents to people. Instead of being presented in a single format, most web pages are formatted by combing a plurality of media elements, such as text or pictures, to present richer and more diverse information. In particular, as intelligent mobile terminals are widely used, “transfer” and “sharing” become important constituent parts of the current Internet. For example, a user may conveniently release what he or she sees and hears, and his or her feelings in daily work and life on the Internet by using a smartphone, thereby sharing information as well as enriching communications with others.

The inventor finds, during a process of implementing the present invention, that formatting of contents in some web pages may not be meticulous enough. In particular, web page contents autonomously released by a user by using a mobile terminal have a great arbitrariness in formatting, and elements in a web page are disordered in direction, size, or location. For example, an angle between a picture released by a user and its corresponding text is 90 degrees, that is, the picture that should be placed vertically is placed horizontally. Consequently, other users need to switch between a text direction and a picture direction to smoothly understand meanings of the text during reading; as a result, it is very inconvenient for users to read. In addition, because different users may have different reading habits, it is impossible that a formatting style of contents in a same web page adapts to all users, and consequently, a formatting manner is not flexible enough, and a web page browser is not user-friendly enough.

### SUMMARY

Embodiments of the present invention provide a web page reformatting method and apparatus, a computing device, and a non-transitory machine readable storage medium, to resolve the problem in the prior art that a web page formatting manner is not flexible enough, and is not user-friendly enough.

To resolve the foregoing technical problem, the embodiments of the present invention disclose the following technical solutions:

According to an aspect of the present invention, a web page reformatting method is provided, including: detecting a predefined action performed by a user on a target element in a web page, where the predefined action indicates that the user expects to change a formatting manner of the target element in the web page; acquiring an action parameter of the predefined action in response to that the predefined action is detected; computing an updated style of the target element according to the action parameter; and reformatting the target element in the web page according to the updated style.

Preferably, the method may further include: detecting a trigger operation of the user, determining whether the trigger operation meets a preset trigger condition, and in a case in which the trigger operation meets the preset trigger condition, performing the step of detecting a predefined action performed by a user on a target element in a web page. The trigger condition may include: the trigger operation being a preset screen touching operation. The preset screen touching operation may include: a screen touching operation, of which holding time exceeds a first time threshold, within an effective display range of the target element; or the trigger operation being selecting a preset trigger menu item.

Preferably, the predefined action may include: a screen touching gesture operation of rotation, and/or scaling, and/or translation performed on the target element by the user; or selection of a preset action menu item by the user, where the action menu item is used to perform an operation of rotation, and/or scaling, and/or translation on the target element. Correspondingly, the action parameter may include: a rotation angle, and/or a scaling coefficient, and/or a translation target location.

Preferably, the action parameter may further include coordinates of an event center point of the predefined action, and the method may further include: determining whether the coordinates of the event center point are within the effective display range of the target element; and in a case in which the coordinates of the event center point are within the effective display range of the target element, performing the step of computing an updated style of the target element according to the action parameter.

Preferably, the step of computing an updated style of the target element according to the action parameter may include: converting the action parameter into a transform attribute of a CSS standard; and computing the updated style of the target element according to the transform attribute acquired by conversion and an original transform attribute of the target element.

According to another aspect of the present invention, a web page reformatting apparatus is provided, including: a detecting unit, configured to detect a predefined action performed by a user on a target element in a web page, where the predefined action indicates that the user expects to change a formatting manner of the target element in the web page; an acquiring unit, configured to acquire an action parameter of the predefined action in response to that the detecting unit detects the predefined action; a computing unit, configured to compute an updated style of the target element according to the action parameter acquired by the acquiring unit; and a formatting unit, configured to reformat the target element in the web page according to the updated style computed by the computing unit.

Preferably, the apparatus may further include: a detecting and determining unit, configured to detect a trigger operation of the user, and determine whether the trigger operation meets a preset trigger condition, where in a case in which the trigger operation meets the preset trigger condition, the detecting unit detects the predefined action performed by the user on the target element in the web page. The trigger condition may include: the trigger operation being a preset screen touching operation. The preset screen touching operation may include: a screen touching operation, of which holding time exceeds a first time threshold, within an effective display range of the target element; or the trigger operation being selecting a preset trigger menu item.

Preferably, the detecting unit may include: a first detecting subunit, configured to detect a screen touching gesture operation of rotation, and/or scaling, and/or translation performed on the target element by the user; or a second detecting subunit, configured to detect selection of a preset action menu item by the user, where the action menu item is used to perform an operation of rotation, and/or scaling, and/or translation on the target element. The action parameter acquired by the acquiring unit may include: a rotation angle, and/or a scaling coefficient, and/or a translation target location.

Preferably, the action parameter acquired by the acquiring unit may further include coordinates of an event center point of the performed action, and the apparatus may further include: a determining unit, configured to determine whether the coordinates of the event center point are within the effective display range of the target element, and in a case in which the determining unit determines that the coordinates of the event center point are within the effective display range of the target element, the computing unit computes the updated style of the target element according to the action parameter acquired by the acquiring unit.

Preferably, the computing unit may include: a converting subunit, configured to convert the action parameter acquired by the acquiring unit into a transform attribute of a CSS standard; and a computing subunit, configured to compute the updated style of the target element according to the transform attribute acquired by conversion performed by the converting subunit and an original transform attribute of the target element.

According to another aspect of the present invention, a computing device is provided, including: a display screen, configured to display a web page; a detector, configured to detect a predefined action performed by a user on a target element in the web page, where the predefined action indicates that the user expects to change a formatting manner of the target element in the web page; and a processor, configured to acquire an action parameter of the predefined action from the detector in response to that the detector detects the predefined action, compute an updated style of the target element according to the action parameter, reformat the target element in the web page according to the updated style, and instruct the display screen to display the reformatted web page.

According to another aspect of the present invention, a non-transitory machine readable storage medium is provided, which stores an executable code, where when the executable code is executed by a processor, the processor is enabled to perform the method according to the present invention.

It can be seen according to the foregoing technical solutions that, according to the web page reformatting method and apparatus that are provided in the embodiments of the present invention, by acquiring an action performed by a user on a target element in a web page and a corresponding action parameter and computing an updated style of the target element in the web page according to the action parameter, the objective of reformatting the target element in the web page is achieved. The technical solutions of the present invention allow users to adjust the format of disorderly web page contents and can adapt to reading styles of different users, thereby providing good flexibility and greatly improving users' reading experience.

### BRIEF DESCRIPTION OF THE DRAWINGS

To describe technical solutions in embodiments of the present invention or in the prior art more clearly, the following briefly describes the accompanying drawings required for describing the embodiments or the prior art. Apparently, a person of ordinary skill in the art may further derive other drawings from these accompanying drawings without inventive efforts.

FIG. 1 is a schematic flowchart of an embodiment of a web page reformatting method according to the present invention;

FIG. 2 is a schematic flowchart of another embodiment of a web page reformatting method according to the present invention;

FIG. 3 is a schematic diagram of a web page before reformatting according to an embodiment of the present invention;

FIG. 4 is a schematic diagram of a process of reformatting a web page according to an embodiment of the present invention;

FIG. 5a is a schematic diagram of a web page after reformatting according to an embodiment of the present invention;

FIG. 5b is a schematic diagram of a web page after reformatting according to an embodiment of the present invention;

FIG. 6 is a schematic structural diagram of an embodiment of a web page reformatting apparatus according to an embodiment of the present invention;

FIG. 7 is a schematic structural diagram of another embodiment of a web page reformatting apparatus according to an embodiment of the present invention;

FIG. 8 is a schematic structural diagram of a computing unit according to an embodiment of the present invention; and

FIG. 9 is a schematic block diagram of an embodiment of a computing device according to the present invention.

### DETAILED DESCRIPTION

First, a description is made to an embodiment of a web page reformatting method of the present invention.

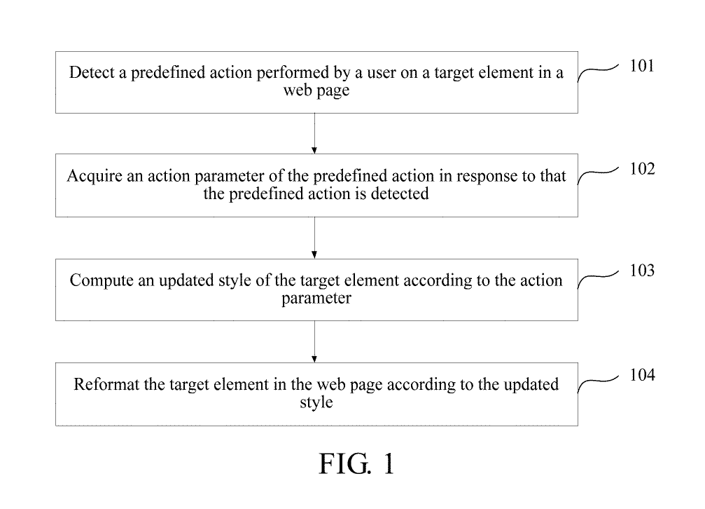

FIG. 1 is a schematic flowchart of an embodiment of a web page reformatting method according to the present invention.

Referring to FIG. 1, according to the web page reformatting method of the present invention, in step 101, a predefined action performed by a user on a target element in a web page is detected. The predefined action may indicate that the user expects to change a formatting manner of the target element in the web page.

For example, the predefined action may include: rotation, and/or scaling, and/or translation.

The target element may be a media element such as text, a picture, a video, or an animation.

In step 102, an action parameter of the predefined action is acquired in response to that the predefined action is detected.

For example, corresponding to the foregoing predefined action, the action parameter may include: a rotation angle, and/or a scaling coefficient, and/or a translation target location.

In step 103, an updated style of the target element is computed according to the action parameter.

For example, the updated style may include an updated format, updated coordinates, and the like.

In step 104, the target element is reformatted in the web page according to the updated style.

It should be noted that, an execution body of this embodiment and other embodiments of the web page reformatting method of the present invention may be a web page browser itself, or located on one side of the browser.

According to the web page reformatting method and apparatus that are provided in the embodiments of the present invention, by acquiring a predefined action performed by a user on a target element in a web page and a corresponding action parameter and computing an updated style of the target element in the web page according to the action parameter, the objective of reformatting the target element in the web page is achieved.

The technical solution of the present invention allows users to adjust the format of disordered web page contents and can adapt to reading styles of different users, thereby providing good flexibility and greatly improving users' reading experience.

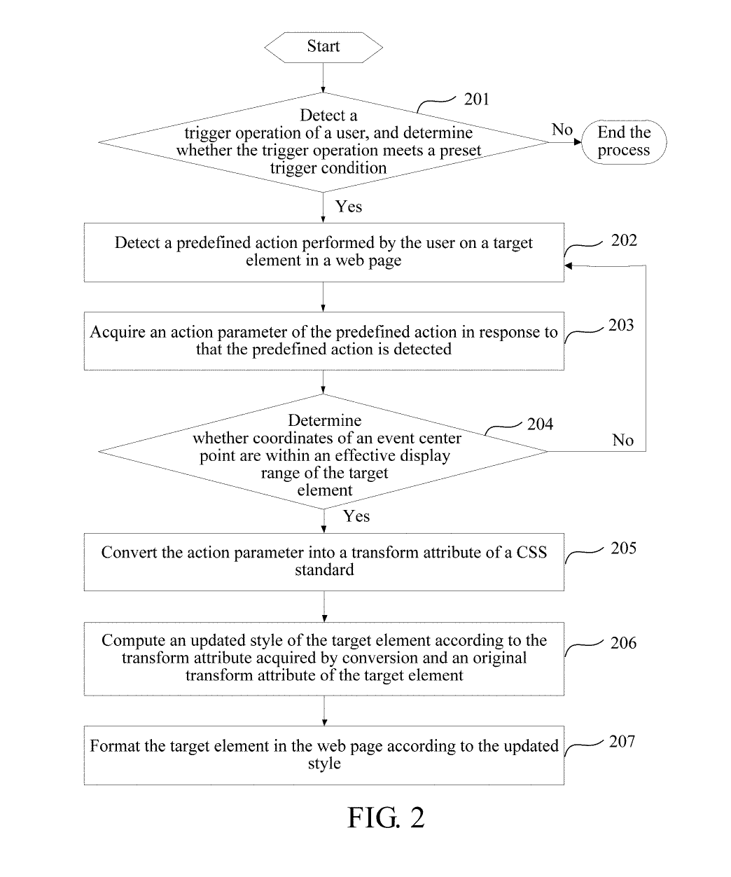

FIG. 2 is a schematic flowchart of another embodiment of a web page reformatting method according to the present invention.

Referring to FIG. 2, in step 201, a trigger operation of a user is detected, and whether the trigger operation meets a preset trigger condition is determined; if the trigger operation meets the preset trigger condition, step 202 is performed, and otherwise, the process is ended.

For example, a web page reformatting function of the present invention may be set to be disabled by default, to prevent mis-operations by a user from affecting normal reading during his or her reading. Only when the user inputs a correct trigger operation (a trigger operation that meets a preset trigger condition) can the function of the present invention be enabled.

As an example, the trigger operation that meets the preset trigger condition may be a preset screen touching operation. The preset screen touching operation includes: a screen touching operation, of which holding time exceeds a first time threshold, within an effective display range of a target element, that is, a gesture action of “touching and holding” the target element. Using an intelligent touch screen terminal as an example, the user trigger operation that meets a trigger condition may be set as “touching and holding” a target picture in a web page for over one second, to trigger the web page reformatting function of the present invention. To be more intuitive, the target picture may also display an effect, such as shadow or flash after being “touched and held”. This is not a key point of the technical solutions of the present invention, and therefore details are not described.

Optionally, the preset screen touching operation may also be another screen touching gesture, for example, a screen touching operation of successively tapping twice within the effective display range of the target element, that is, a gesture action of “double-tapping” the target element. Specific screen touching gesture forms are not limited.

Optionally, the trigger operation that meets a preset trigger condition may also be selecting a preset trigger menu item. For example, a menu item of a “reformatting” function may be added, so that the user triggers the web page reformatting function of the present invention by tapping the menu item or selecting the menu item by pressing a button.

Either the screen touching operation or the trigger menu item may be set as the trigger manner, or both of these manners can be set as the trigger manner at the same time.

In step 202, a predefined action performed by the user on a target element in a web page is detected.

For example, the predefined action may include: a screen touching gesture operation of rotation, and/or scaling, and/or translation.

Optionally, the predefined action performed by the user on the target element in the web page may also be performed by selecting the preset menu item. Correspondingly, in step 202, that the user performs the foregoing predefined action, for example, the operation of rotation, and/or scaling, and/or translation, according to the preset menu item may be detected.

In step 203, an action parameter of the predefined action is acquired in response to that the predefined action is detected.

For example, corresponding to the foregoing predefined action, the action parameter may include: a rotation angle, and/or a scaling coefficient, and/or a translation target location.

Further, the action parameter may further include coordinates of an event center point of the foregoing performed predefined action.

In this case, in step 204, whether coordinates of an event center point are within an effective display range of the target element may be determined.

In a case in which the coordinates of the event center point are within the effective display range of the target element, step 205 is performed, and otherwise, step 202 is returned to, to continue to detect the predefined action performed by the user.

In other embodiments of the present invention, when the coordinates of the event center point are not within the effective display range of the target element, the process may also be ended.

The “event center point” refers to a center coordinate point generated by performing an operation on the target element on a terminal device. For example, an approximate circle having an area close to an area of a fingertip is acquired in response to a screen touching operation performed by a user touching a screen with his or her finger. A particular algorithm is used, for example, by removing discrete parts in the approximately circular region, and then performing an average algorithm in a horizontal direction and a vertical direction, a pair of coordinates used as an “event center point” of the screen touching operation can be acquired.

Each element in a web page, either a word or a picture, has a particular effective display range. If an event center point falls within the effective display range of an element, the predefined action is considered to function on this element. In this case, the method is performed to acquire the updated style of the target element by computing.

As an example, the updated style of the target element may be acquired by computing based on a transform (transform) attribute of a cascading style sheet (CSS, Cascading Style Sheet) standard.

For example, as shown in FIG. 2, in step 205, the action parameter may be converted into a transform (transform) attribute of a cascading style sheet (CSS) standard.

The action parameter, for example, a rotation angle, a scaling coefficient, or a translation target location, is converted into a transform attribute of a standard cascading style sheet CSS, and the transform attributes are rotate(angle), scale(x, y), and translate(x, y) respectively. The CSS transform attribute can implement rotation, scaling, translation, or skew(angle) on an element. Reference may be made to a CSS reference manual for specific methods, which are the prior art, and details are not described herein again.

Then, in step 206, an updated style of the target element is computed according to a transform attribute acquired by conversion and an original transform attribute of the target element.

The target element itself also has a transform attribute used to identify a location of the element in the web page. The transform attribute of the target element itself is superposed to the transform attribute after conversion for computing, to acquire the updated style of the target element. The updated style may include an updated format and updated coordinates.

Then, in step 207, the target element may be formatted in the web page according to the updated style.

The target element is output on a screen according to the updated style. Optionally, for a more aesthetic web page formatting, micro-adjustment may further be performed on the target element. For example, a padding attribute is set to adjust a padding of the target element, to prevent the target element from overlapping with or covering another element. The method may also be repeatedly used to reformat the web page until an optimal reading effect is achieved. That is, the “reformatting” function provided in the solution may be used for multiple times, and additive effects may be generated. For example, a picture is first rotated for 90 degrees, and after this reformatting is completed, if the user thinks that the format is still not aesthetic enough, the picture may further be rotated for 45 degrees. Then, a final effect is that the picture is rotated for 135 degrees in total.

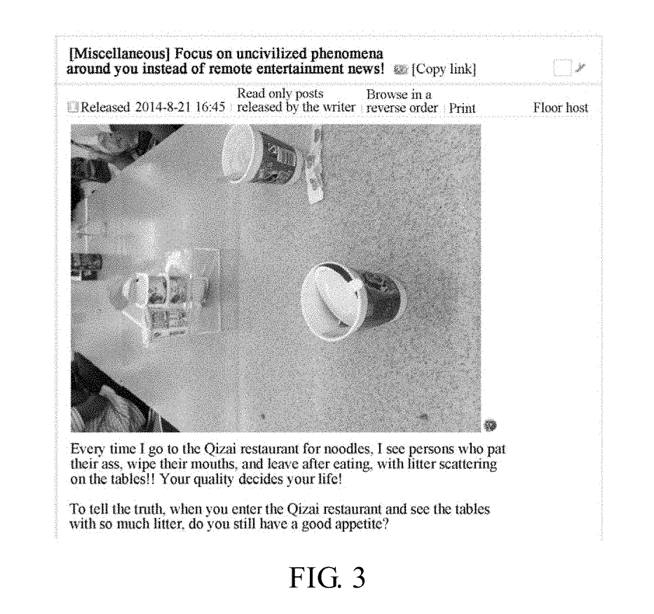

The following describes, by using an actual web page as an example, an effect generated by the solution. FIG. 3 is a schematic diagram of a web page before reformatting of a post released by a user in a forum. As shown in the schematic diagram of the web page in FIG. 3, a user uploads a photo taken at will, and attaches a comment on the photo. However, the photo that should be vertically placed is horizontally placed, and a cup, a table, and persons in the photo are inclined. Consequently, it is very inconvenient for a reader to read the post. The reader needs to switch between a text direction and a picture direction, to correspond contents in the photo to the meaning of text.

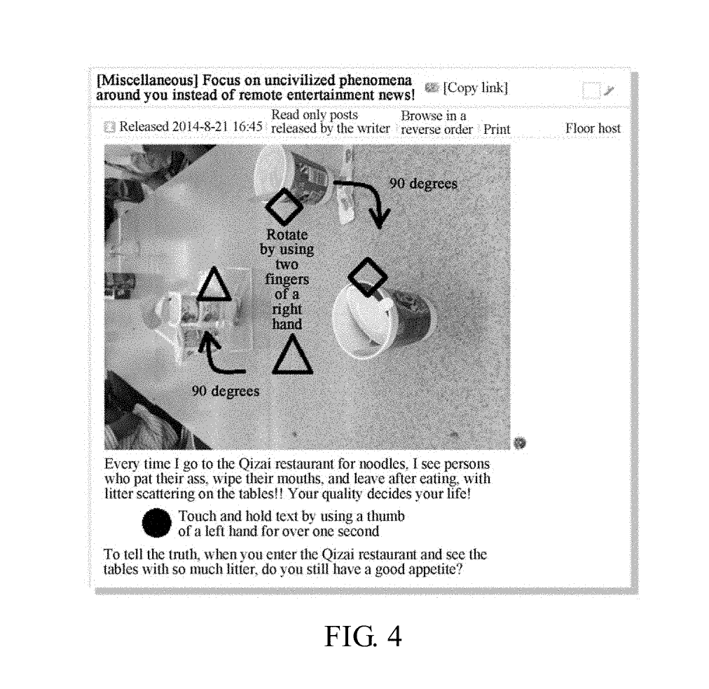

In this case, the reader may touch and hold the text part by using a left hand to trigger a reformatting function, and then make a screen touching gesture of rotating clockwise for 90 degrees on the picture by using a forefinger and a thumb of a right hand (or select a corresponding trigger menu item by using a menu). FIG. 4 is a schematic diagram of a process of reformatting the web page by the reader. Triangles and quadrangles in the drawing respectively represent directions of rotation actions of the thumb and the forefinger of the right hand on a screen.

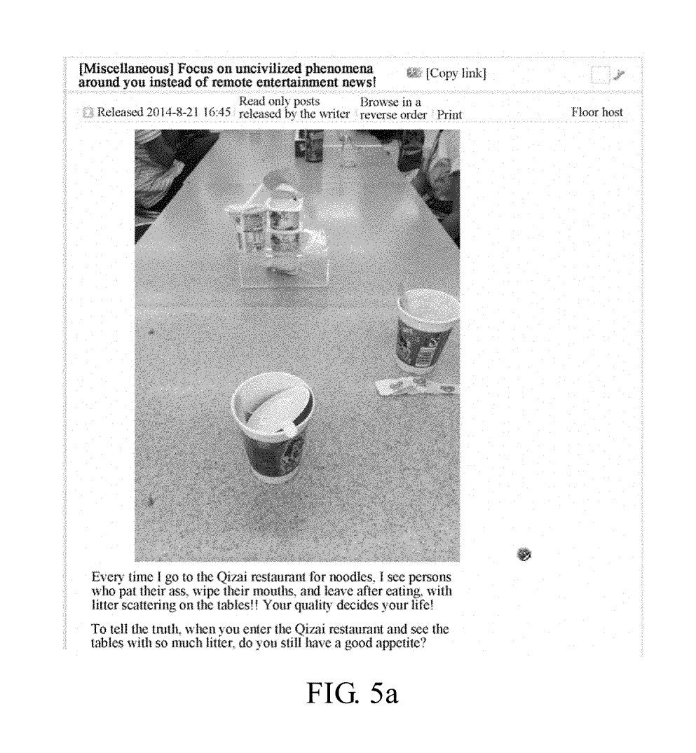

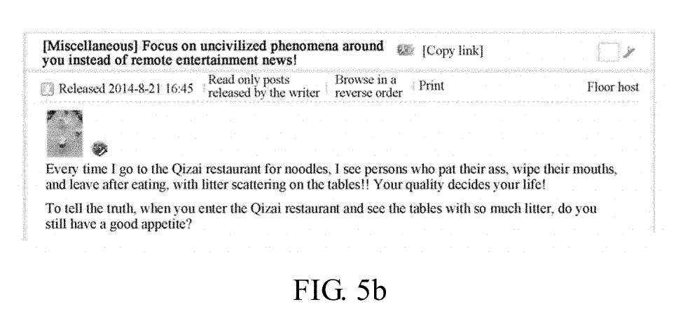

FIG. 5a is a schematic diagram of a web page after reformatting. After the function of the solution is performed, the picture in the post is vertically placed, and the erect table and persons who are sitting can be normally recognized. It is very easy to see that a few ice cream cups with upward openings scatter on the table that was originally clean and tidy, and immediately, the reader shares the feeling with the writer about an uncivilized phenomenon described in the text content of the post, thereby making a web page browser more user-friendly. FIG. 5b shows that the method in the present invention is repeatedly used, and then a size of the picture part is scaled down to one tenth of the original size, so that the picture and the text visually match better.

It can be seen according to the foregoing embodiment that, according to the web page reformatting method provided in this embodiment of the present invention, a trigger operation input by a user is first detected; when the trigger operation meets a preset trigger condition, an action performed by the user on a target element in a web page and a corresponding action parameter are acquired, and an updated style of the target element in the web page is computed according to the action parameter, so as to achieve the objective of reformatting the target element in the web page. The technical solution of the present invention allows users to adjust the format of disordered web page contents and can adapt to reading styles of different users, thereby providing good flexibility and greatly improving users' reading experience.

Corresponding to the embodiments of the web page reformatting method of the present invention, the present invention further provides embodiments of a corresponding web page reformatting apparatus.

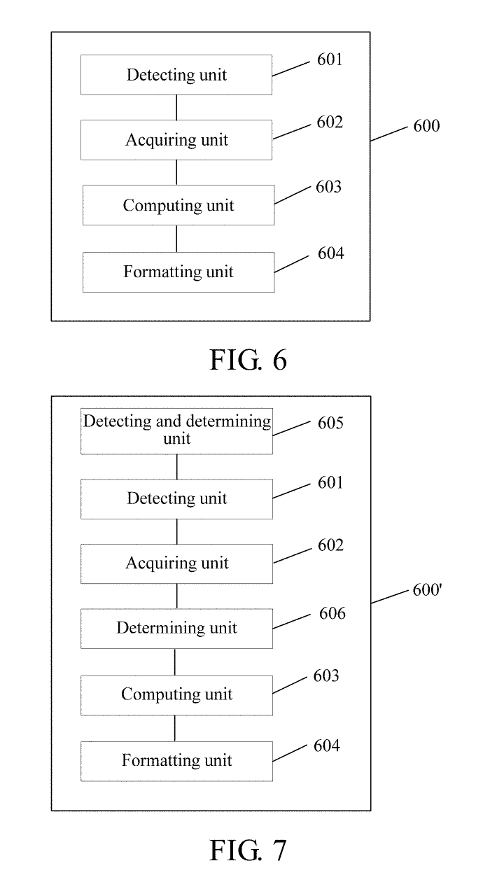

FIG. 6 is a schematic structural diagram of a web page reformatting apparatus 600 according to an embodiment of the present invention. The web page reformatting apparatus 600 specifically may be a web page browser, or may be provided on one side of a web page browser.

Referring to FIG. 6, the web page reformatting apparatus 600 may include: a detecting unit 601, an acquiring unit 602, a computing unit 603, and a formatting unit 604.

The detecting unit 601 detects a predefined action performed by a user on a target element in a web page. The predefined action may indicate that the user expects to change a formatting manner of the target element in the web page.

For example, the predefined action may include: rotation, and/or scaling, and/or translation.

The target element may be a media element such as text, a picture, a video, or an animation.

The acquiring unit 602 acquires an action parameter of the predefined action in response to that the detecting unit 601 detects the predefined action.

For example, corresponding to the foregoing predefined action, the action parameter may include: a rotation angle, and/or a scaling coefficient, and/or a translation target location.

The computing unit 603 is configured to compute an updated style of the target element according to the action parameter acquired by the acquiring unit 602.

For example, the updated style may include an updated format, updated coordinates, and the like.

The formatting unit 604 is configured to format the target element in the web page according to the updated style computed by the computing unit 603.

FIG. 7 is a schematic structural diagram of a web page reformatting apparatus 600′ according to another embodiment of the present invention.

Optionally, referring to FIG. 7, in addition to a detecting unit 601, an acquiring unit 602, a computing unit 603, and a formatting unit 604 shown in FIG. 6, the web page reformatting apparatus 600′ may further include a detecting and determining unit 605. Functions of the detecting unit 601, the acquiring unit 602, the computing unit 603, and the formatting unit 604 of the web page reformatting apparatus 600′ are basically the same as functions of the units in the web page reformatting apparatus 600 described with reference to FIG. 6, and details are not described herein again.

The determining unit 605 detects a trigger operation of a user, and determines whether the trigger operation meets a preset trigger condition. In a case in which the trigger operation meets the preset trigger condition, the detecting unit 601 performs its function, that is, detecting a predefined action performed by the user on a target element in a web page.

Optionally, the trigger operation that meets the preset trigger condition may be a preset screen touching operation. The detecting and determining unit 605 may detect the trigger operation of the user, and determine whether the trigger operation is a preset screen touching operation. The preset screen touching operation includes: a screen touching operation, of which holding time exceeds a first time threshold, within an effective display range of the target element.

Optionally, the trigger operation that meets the preset trigger condition may also be selecting a preset trigger menu item. The detecting and determining unit 605 may detect the trigger operation of the user, and determine whether the trigger operation is the preset trigger menu item.

The detecting unit 601 may include: a first detecting subunit (not shown in the drawing), configured to detect a screen touching gesture operation of rotation, and/or scaling, and/or translation performed on the target element by the user.

Or, optionally, the detecting unit 601 may include: a second detecting subunit (not shown in the drawing), configured to detect a selection of a preset action menu item by the user. The action menu item is used to perform an operation of rotation, and/or scaling, and/or translation on the target element.

Preferably, an action parameter acquired by the acquiring unit 602 may further include coordinates of an event center point of a performed action. As shown in FIG. 7, the web page reformatting apparatus may further include a determining unit 606.

The determining unit 606 determines whether the coordinates of the event center point are within the effective display range of the target element.

In a case in which the determining unit 606 determines that the coordinates of the event center point are within the effective display range of the target element, the computing unit 603 computes an updated style of the target element according to the action parameter acquired by the acquiring unit 602.

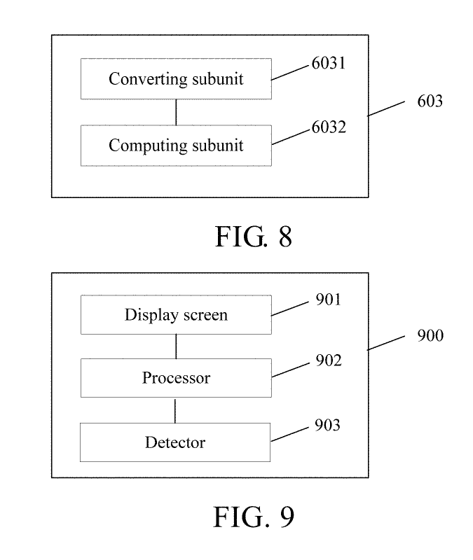

FIG. 8 is a possible schematic structural diagram of a computing unit 603.

As shown in FIG. 8, the computing unit 603 may include: a converting subunit 6031 and a computing subunit 6032.

The converting subunit 6031 converts an action parameter acquired by an acquiring unit 602 into a transform attribute of a CSS standard.

The computing subunit 6032 computes an updated style of a target element according to the transform attribute acquired by conversion performed by the converting subunit 6031 and an original transform attribute of the target element.

Specific manners of performing operations by the modules and units in the apparatus of the foregoing embodiment are described in detail in the embodiment related to the method, and details are not described herein. Reference may be made to some description in the method embodiment for related content.

It can be seen according to the foregoing embodiment that, according to the web page reformatting apparatus provided in this embodiment of the present invention, by acquiring an action performed by a user on a target element in a web page and a corresponding action parameter and computing an updated style of the target element in the web page according to the action parameter, the objective of reformatting the target element in the web page is achieved. The technical solution of the present invention allows users to adjust the format of disorderly web page contents and can adapt to reading styles of different users, thereby providing a good flexibility and greatly improving users' reading experience.

FIG. 9 is a schematic block diagram of a computing device 900 that can display a web page according to an embodiment of the present invention.

The computing device 900 may be a desktop computer, a notebook computer, a tablet computer, an intelligent mobile phone, or the like.

As shown in FIG. 9, the computing device 900 may include a display screen 901, a processor 902, and a detector 903.

The display screen 901 is configured to display a web page.

The detecting unit 903 detects a predefined action performed by a user on a target element in a web page. The predefined action indicates that the user expects to change a formatting manner of the target element in the web page.

As stated above, for example, the predefined action may include: rotation, and/or scaling, and/or translation.

The target element may be a media element such as text, a picture, a video, or an animation.

For a common computer, the detector 903 may be a detection apparatus configured to detect input information of a mouse or a keyboard.

In a case in which the display screen 901 is a touch display screen, the detector 903 may be a sensor configured to sense a touching action of a user on the touch display screen or another detection apparatus. That is, the display screen 901 and the detector 903 are both on the touch display screen.

The processor 902 acquires an action parameter of the predefined action from the detector 903 in response to that the detector 903 detects the predefined action, computes an updated style of the target element according to the action parameter, reformats the target element in the web page according to the updated style, and instructs the display screen 901 to display the reformatted web page.

For example, corresponding to the foregoing predefined action, the action parameter may include: a rotation angle, and/or a scaling coefficient, and/or a translation target location.

For example, the updated style may include an updated format, updated coordinates, and the like.

Preferably, the touch display screen 901 may further detect a trigger operation of the user. The processor 902 may determine whether the trigger operation meets a preset trigger condition. In a case in which the trigger operation meets the preset trigger condition, the predefined action performed by the user on the target element in the web page is detected.

The trigger condition may be the same as the trigger condition in the foregoing web page reformatting method and apparatus described with reference to FIG. 2 and FIG. 7, and details are not described herein again.

The manner of computing the updated style of the target element by the processor 902 may also be the same as the computing manner in the foregoing web page reformatting method and apparatus described with reference to FIG. 1, FIG. 2, FIG. 7, and FIG. 8, and details are not described herein again.

A person skilled in the art can clearly know that the technology in the embodiments of the present invention may be implemented by using software in combination with necessary universal hardware. The universal hardware includes a universal integrated circuit, a universal CPU, a universal memory, a universal element, or the like; and certainly, the technology may also be implemented by using special-purpose hardware that includes a special-purpose integrated circuit, a special-purpose CPU, a special-purpose memory, a special-purpose element, or the like. However, in most cases, the former is a better implementation manner. Based on such understanding, the essence, or the part contributing to the prior art, of the technical solutions of the present invention may be reflected in a form of a software product. The computer software product may be stored in a storage medium, such as a read-only memory (ROM, Read-Only Memory), a random access memory (RAM, Random Access Memory), a magnetic disk, or an optical disc, and includes several instructions for instructing a computer device (which may be a personal computer, a server, or a network device) to perform the method described in the embodiments or some parts of the embodiments of the present invention.

Therefore, the foregoing technical concept of the present invention may further be implemented as a non-transitory machine readable storage medium, which stores an executable code. When the executable code is executed by a processor, the processor is enabled to perform the foregoing method.

On another aspect, the foregoing technical concept of the present invention may further be implemented as a computing device. The computing device includes a processor and a non-transitory machine readable storage medium. The non-transitory machine readable storage medium stores an executable code. When the executable code is executed by the processor, the processor is enabled to perform the foregoing method.

In addition, the foregoing technical concept of the present invention may further be implemented as a computer program product. The computer program product includes an executable code. When the executable code is executed by a processor, the processor is enabled to perform the foregoing method.

The embodiments in this specification are all described in a progressive manner, and reference may be made to each other for same or similar parts among the embodiments, and each embodiment focuses on a difference from other embodiments. Especially, system embodiments are basically similar to the method embodiments, and therefore are described briefly; and reference may be made to partial descriptions in the method embodiments for related parts.

The foregoing implementation manners of the present invention do not constitute a limitation to the protection scope of the present invention. Any modification, equivalent replacement, and improvement made within the spirit and principle of the present invention shall fall within the protection scope of the present invention.

1. A web page reformatting method, comprising:
detecting a predefined action performed by a user on a target element in a web page, wherein the predefined action indicates that the user expects to change a formatting manner of the target element in the web page;
acquiring an action parameter of the predefined action in response to that the predefined action is detected;
computing an updated style of the target element according to the action parameter; and
reformatting the target element in the web page according to the updated style.

2. The method according to claim 1, further comprising:
detecting a trigger operation of the user, determining whether the trigger operation meets a preset trigger condition, and in a case in which the trigger operation meets the preset trigger condition, performing the step of detecting a predefined action performed by a user on a target element in a web page, wherein the trigger condition comprises:
the trigger operation being a preset screen touching operation, wherein the preset screen touching operation comprises: a screen touching operation, of which holding time exceeds a first time threshold, within an effective display range of the target element; or
the trigger operation being selecting a preset trigger menu item.

3. The method according to claim 1, wherein
the predefined action comprises:
a screen touching gesture operation including at least one of rotation, scaling, and translation performed on the target element by the user; or
selection of a preset action menu item by the user, wherein the action menu item is used to perform an operation including at least one of rotation, scaling, and translation on the target element, wherein
the action parameter of rotation comprises a rotation angle, the action parameter of scaling comprises a scaling coefficient, and the action parameter of translation comprises a translation target location.

4. The method according to claim 1, wherein
the action parameter further comprises coordinates of an event center point of the predefined action, and
the method further comprises:
determining whether the coordinates of the event center point are within an effective display range of the target element; and
in a case in which the coordinates of the event center point are within the effective display range of the target element, performing the step of computing an updated style of the target element according to the action parameter.

5. The method according to claim 1, wherein the step of computing an updated style of the target element according to the action parameter comprises:
converting the action parameter into a transform attribute of a CSS standard; and
computing the updated style of the target element according to the transform attribute acquired by conversion and an original transform attribute of the target element.

6. A web page reformatting apparatus, comprising:
a detecting unit, configured to detect a predefined action performed by a user on a target element in a web page, wherein the predefined action indicates that the user expects to change a formatting manner of the target element in the web page;
an acquiring unit, configured to acquire an action parameter of the predefined action in response to that the detecting unit detects the predefined action;
a computing unit, configured to compute an updated style of the target element according to the action parameter acquired by the acquiring unit; and
a formatting unit, configured to reformat the target element in the web page according to the updated style computed by the computing unit.

7. The apparatus according to claim 6, further comprising:
a detecting and determining unit, configured to detect a trigger operation of the user, and determine whether the trigger operation meets a preset trigger condition, wherein in a case in which the trigger operation meets the preset trigger condition, the detecting unit detects the predefined action performed by the user on the target element in the web page, and the trigger condition comprises:
the trigger operation being a preset screen touching operation, wherein the preset screen touching operation comprises: a screen touching operation, of which holding time exceeds a first time threshold, within an effective display range of the target element; or
the trigger operation being selecting a preset trigger menu item.

8. The apparatus according to claim 6, wherein the detecting unit comprises:
a first detecting subunit, configured to detect a screen touching gesture operation including at least one of rotation, scaling, and translation performed on the target element by the user; or
a second detecting subunit, configured to detect selection of a preset action menu item by the user, wherein the action menu item is used to perform an operation including at least one of rotation, scaling, and translation on the target element, wherein
the action parameter of rotation comprises a rotation angle, the action parameter of scaling comprises a scaling coefficient, and the action parameter of translation comprises a translation target location.

9. The apparatus according to claim 6, wherein the action parameter acquired by the acquiring unit further comprises coordinates of an event center point of the performed action, and
the apparatus further comprises: a determining unit, configured to determine whether the coordinates of the event center point are within the effective display range of the target element, and
in a case in which the determining unit determines that the coordinates of the event center point are within the effective display range of the target element, the computing unit computes the updated style of the target element according to the action parameter acquired by the acquiring unit.

10. The apparatus according to claim 6, wherein the computing unit comprises:
a converting subunit, configured to convert the action parameter acquired by the acquiring unit into a transform attribute of a CSS standard; and
a computing subunit, configured to compute the updated style of the target element according to the transform attribute acquired by conversion performed by the converting subunit and an original transform attribute of the target element.

11. A computing device, comprising:
a display screen, configured to display a web page;
a detector, configured to detect a predefined action performed by a user on a target element in the web page, wherein the predefined action indicates that the user expects to change a formatting manner of the target element in the web page; and
a processor, configured to acquire an action parameter of the predefined action from the detector in response to that the detector detects the predefined action, compute an updated style of the target element according to the action parameter, reformat the target element in the web page according to the updated style, and instruct the display screen to display the reformatted web page.

12. A non-transitory machine readable storage medium, which stores an executable code, wherein when the executable code is executed by a processor, the processor is enabled to perform a method comprising:
detecting a predefined action performed by a user on a target element in a web page, wherein the predefined action indicates that the user expects to change a formatting manner of the target element in the web page;
acquiring an action parameter of the predefined action in response to that the predefined action is detected;
computing an updated style of the target element according to the action parameter; and
reformatting the target element in the web page according to the updated style.

13. The non-transitory machine readable storage medium of claim 12, wherein the method further comprises:
detecting a trigger operation of the user, determining whether the trigger operation meets a preset trigger condition, and in a case in which the trigger operation meets the preset trigger condition, performing the step of detecting a predefined action performed by a user on a target element in a web page, wherein the trigger condition comprises:
the trigger operation being a preset screen touching operation, wherein the preset screen touching operation comprises: a screen touching operation, of which holding time exceeds a first time threshold, within an effective display range of the target element; or
the trigger operation being selecting a preset trigger menu item.

14. The non-transitory machine readable storage medium of claim 12, wherein the predefined action comprises:
a screen touching gesture operation of rotation, and/or scaling, and/or translation performed on the target element by the user; or
selection of a preset action menu item by the user, wherein the action menu item is used to perform an operation including at least of rotation, scaling, and translation on the target element, wherein
the action parameter of rotation comprises a rotation angle, the action parameter of scaling comprises a scaling coefficient, and the action parameter of translation comprises a translation target location.

15. The non-transitory machine readable storage medium of claim 12, wherein the action parameter further comprises coordinates of an event center point of the predefined action, and
the method further comprises:
determining whether the coordinates of the event center point are within an effective display range of the target element; and
in a case in which the coordinates of the event center point are within the effective display range of the target element, performing the step of computing an updated style of the target element according to the action parameter.

16. The non-transitory machine readable storage medium of claim 12, wherein the step of computing an updated style of the target element according to the action parameter comprises:
converting the action parameter into a transform attribute of a CSS standard; and
computing the updated style of the target element according to the transform attribute acquired by conversion and an original transform attribute of the target element.
